(19) United States
(12) Patent Application Publication
(10) Pub. No.: US 2010/0132120 A1
(43) Pub. Date: Jun. 3, 2010

(54) Adaptive Seat Cushion Having A Pressure-Relieving Structure

(75) Inventors: James M. Koerlin, Broomfield, CO (US); James L. Christofferson, Longmont, CO (US); Vasily G. Tsuber, Thornton, CO (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: SUNRISE MEDICAL HHG, INC., Longmont, CO (US)

(21) Appl. No.: 12/629,747

(22) Filed: Dec. 2, 2009

Related U.S. Application Data
(60) Provisional application No. 61/119,246, filed on Dec. 2, 2008.

(51) Int. Cl. A47C 20/02; B68G 7/06

(52) U.S. Cl. 5/654; 29/91.1

(57) ABSTRACT

A seat cushion system includes a seat cushion assembly and at least one supplemental pad attached to a portion of the seat cushion assembly. The seat cushion assembly and the at least one supplemental pad include chambers that may be filled with a fluid to provide isolation between a user and a wheelchair or other seating structure.

### CROSS-REFERENCE TO RELATED APPLICATIONS

This application claims the benefit of U.S. Provisional Application No. 61/119,246, filed Dec. 2, 2008, the disclosure of which is incorporated herein by reference.

### BACKGROUND OF THE INVENTION

This invention relates in general to seat cushions having a pressure relieving structure. More specifically, this invention relates to a seat cushion for use with a wheelchair. The seat cushion includes a convoluted upper surface and a supplemental pad that is attachable to the upper surface.

Seat cushions are used to provide a soft seating surface in order to isolate body pressure points from contact with a harder supporting surface. The supporting seating surface may be relatively hard with regard to prolonged contact by the surface to pressure sensitive points of the body. The seating surface may be hard by virtue of the chosen materials, i.e. wood, metal, plastics, and the like. Alternatively, the surface may be relatively soft and flexible, such as a seat sling, which is well known in the art. While the seat slings are typically soft in a relaxed or unloaded condition, they often become harder due to the loading applied to the cushion when the user is seated. The loading produces a “hammock effect” which causes the seating material to stretch as the user's weight is supported by the sling. Thus, the sling becomes taught and may impinge upon sensitive pressure points on the user.

It is known to apply a padding layer or a contoured foam surface to the seat in order to shift seating pressure away from sensitive areas. The contoured foam support surfaces have also included additional foam pad sections to modify the contour of the seating area. Fluid-filled seat pads and other isolation barriers have also been applied between the contoured foam seating surface and the user. It is further known to form a seat cushion having a larger upper surface area in order to reduce contact pressure due to the hammock effect. While these various seating isolation systems have provided some relief to users in a prolonged seated position, it would be desirable to provide a structure having improved isolation characteristics. It would also be desirable to provide a seat isolation pad having an improved structure that is more adaptable to specific user needs.

### SUMMARY OF THE INVENTION

This invention relates to seat cushions for personal mobility vehicles, such as wheelchairs. A seat cushion system comprises a seat cushion assembly having an upper layer and a lower layer that define a chamber. The chamber contains a first isolation fluid. The upper layer has a larger surface area than the lower layer. A supplemental pad is attached to the seat cushion assembly and further contains a second isolation fluid.

A seat cushion system comprises a seat cushion assembly having an upper layer defining a first surface area and a lower layer defining a second surface area. The first surface area is larger than the second surface area and results in excess material on the upper layer. The upper layer and lower layer are secured together by perimeter welds and a plurality of spot welds to form the excess material of the upper layer into a plurality of gathers. The gathers have a seat tension characteristic that permits movement of the excess material of the gathers in response to an applied load and a resulting deflection without a substantial stretching of the excess material that forms the gathers.

A seat cushion system comprises a seat cushion assembly having an upper layer defining a first surface area and a lower layer defining a second surface area where the first surface area is larger than the second surface area. The larger first surface area results in excess material on the upper layer. The upper layer and lower layer are secured together by perimeter welds and a plurality of spot welds to form the excess material of the upper layer into a plurality of gathers. The spot welds further maintain the general localized orientation of the plurality of gathers. At least one of the plurality of gathers contains an isolation fluid.

A seat cushion system is formed by providing an assembly jig having spaced-apart perimeter locating points that define a perimeter and spaced-apart interior locating points that define an interior area. An upper layer and a lower layer are provided, where the upper layer has a greater surface area than the lower layer such that the upper layer includes excess material. The upper layer is positioned on the spaced-apart perimeter locating points and the spaced-apart interior locating points such that the upper layer excess material is disposed between adjacent locating points. The lower layer is positioned onto the locating points and over the upper layer. A spot weld is formed at each of the interior locating points. A seam weld is formed adjacent to the perimeter locating points to form at least one chamber. An isolation fluid is introduced into the at least one chamber.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a photograph of an exploded view of a seat cushion system.

FIG. 2 is a photograph of a user interface side of the seat cushion assembly of FIG. 1.

FIG. 3 is a photograph of a seat interface side, opposite the user interface side, of the seat cushion assembly of FIG. 2.

FIG. 4A is a photograph of a user interface side of a supplemental pad of FIG. 1.

FIG. 4B is a photograph of a cushion attachment side of the supplemental pad of FIG. 4A.

FIG. 4C is an elevational view showing a cavity and a filling port of the supplemental pad of FIG. 4B.

FIG. 5 is an exploded perspective view of a contour-formed upper layer and a lower layer of the seat cushion assembly of FIG. 3.

FIG. 6 is an elevational view, taken along arrow 6-6 in FIG. 5 showing a seam orientation and a plurality of user interface sections of the seat cushion assembly of FIG. 5.

FIG. 7A is an elevational view of an upper layer, prior to contour-forming of the upper layer of the seat cushion assembly of FIG. 5.

FIG. 7B is an elevational view of an alternative embodiment of an upper layer, prior to contour-forming of the upper layer of the seat cushion assembly, similar to FIG. 7A.

FIG. 8 is an elevational view of the lower layer of FIG. 5.

FIG. 9 is a perspective view of an alignment jig used in a method of forming the seat cushion assembly.

FIG. 10 is a perspective view of the alignment jig of FIG. 9 having a seat cushion assembly positioned thereon.

FIG. 11 is an assembly fixture for assembling the supplemental pads of FIGS. 4A and 4B, and further showing a part of the supplemental pad after welding and trimming operations.

FIG. 12 is the supplemental pad part in a twisted configuration prior to inversion and fluid filling.

### DETAILED DESCRIPTION OF THE PREFERRED EMBODIMENT

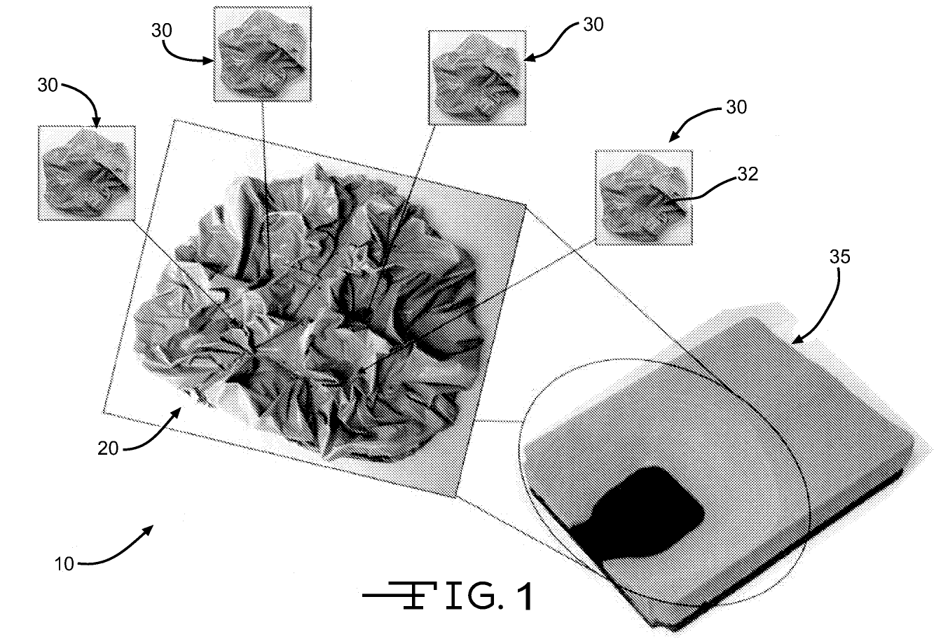

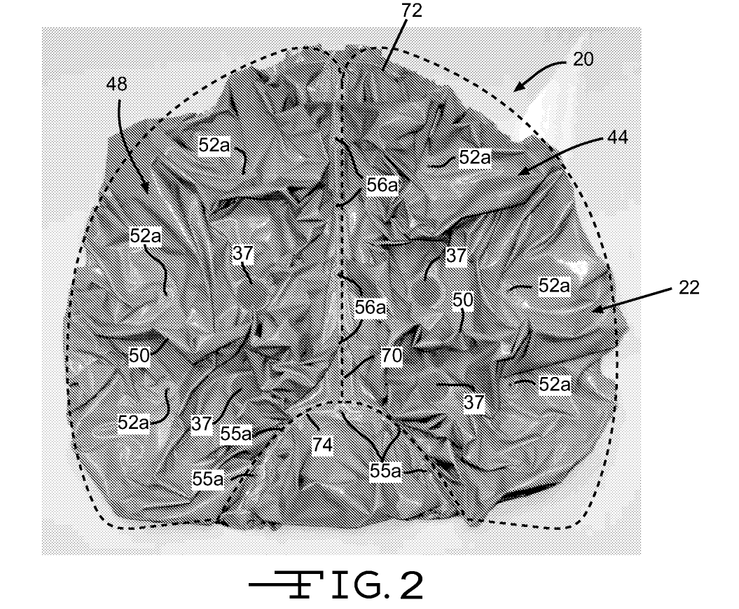

Referring now to the drawings, there is illustrated in FIG. 1 a seat cushion system 10. The seat cushion system 10 is configured for use with a wheelchair having a seating structure, such as a sling or hardboard seat. However, the seat cushion system 10 may be applicable for use in other types of personal mobility vehicles where a user may be seated for prolonged periods, such as scooters. The seat cushion system 10 includes a seat cushion assembly 20 and one or more supplemental pads 30. FIG. 1 shows four supplemental pads 30, though any number of pads 30 may be used, if desired. The seat cushion system 10 may further include a contoured base 35, though such is not required. The seat cushion assembly 20 is illustrated having three chambers 40, 44, and 48, shown outlined in phantom lines in FIG. 2, though a lesser or greater number of chambers may be provided if desired. The chambers 40, 44, and 48 are arranged to support anatomical portions of a user. For example, chamber 40 may be configured to support a user's coccyx region or a user's pubis region, depending on configuration and orientation. Chambers 44 and 48 may be configured to support right and left portions of the buttocks, generally.

One or more of the chambers 40, 44, and 48 may contain an isolation fluid therein. The isolation fluid may be a gas, a liquid, a plurality of beads, or a thixotropic or gelatinous material, as well as combinations of these materials. The isolation fluid may have any desired viscosity, stiffness, damping or other isolation characteristic. Alternatively, one or more of the chambers 40, 44, and 48 may contain a foam material instead of the fluid material or in conjunction with the fluid material, similar to a sponge, if desired. In this context, the term “fluid” may also encompass a fluid filled foam material.

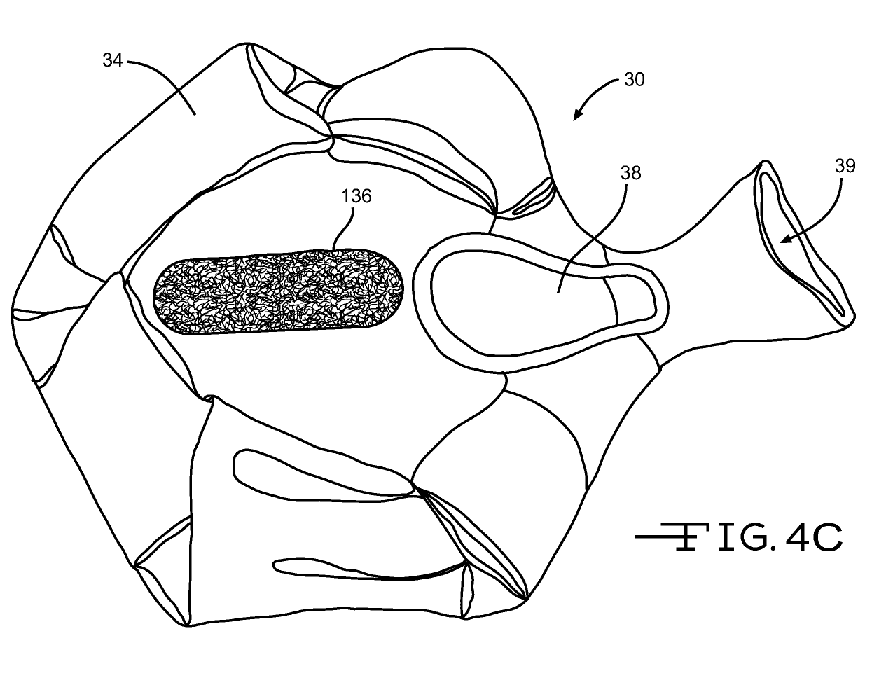

The seat cushion assembly 20 includes an upper layer 22 and a lower layer 24, as shown in FIG. 5. The use of the terms “upper” and “lower” are not intended to be limiting and merely indicate relative positions of generally oppositely spaced apart structures, such as the layers 22 and 24. Preferably, the term “upper” generally signifies portions of the seat cushion system 10 that are oriented in the general direction of the user. The term “lower” generally signifies portions of the seat cushion system 10 that are oriented in the general direction of the seating structure of the wheelchair. Similarly, the terms “left” and “right” are intended to be terms that express relative orientations and not limited to absolute positions. It is further contemplated that the seat cushion system 10 may be oriented in any position relative to the user or the wheelchair, if desired.

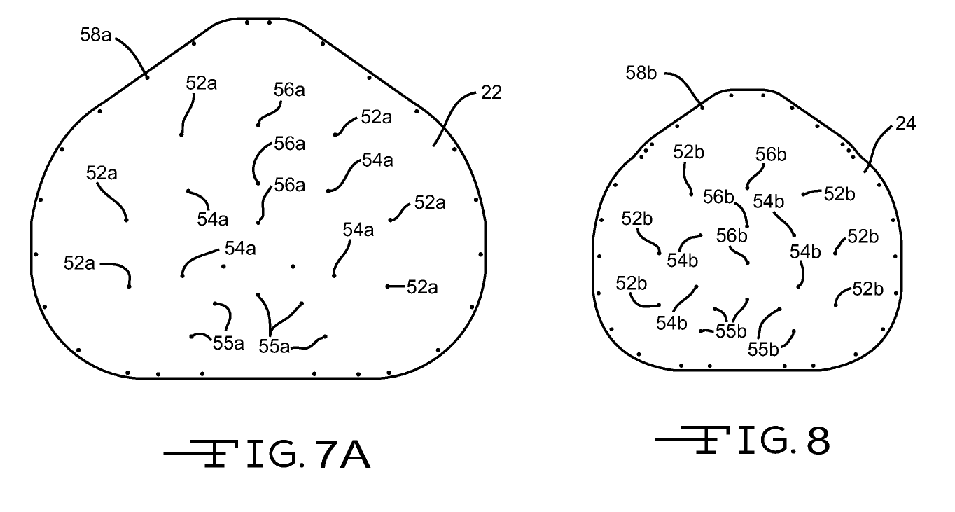

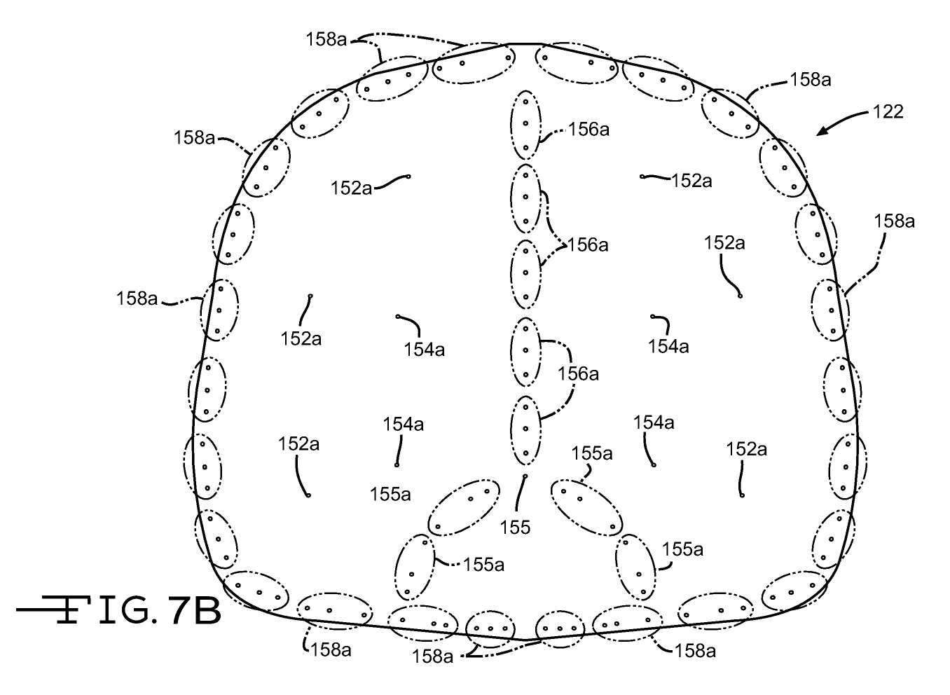

The upper layer 22 is formed having a larger surface area than the lower layer 24. As shown in FIG. 7A, the upper layer 22, when laid out in a generally flat arrangement, is similar in shape yet larger in size when compared to the lower layer 24, shown in FIG. 8. The larger surface area of the upper layer 22 results in the formation of a plurality of gathers 50 when assembled to the lower layer 24, as shown in FIGS. 1 and 2 and as will be described in detail below. A gather is defined as a collection of material into a loosely formed cavity capable of holding a fluid and taking on a wide variety of shapes and fluid displacement characteristics.

The material is a flexible, sheet good, similar to a fabric, that is used to form the seat cushion and pads. The material may be comprised of a single sheet layer or may be formed from multiple sheet layers. In an embodiment of the seat cushion system 10, the material may have a first layer that is formulated for contact with the fluid material used to fill the chambers 40, 44, and 48. The first material layer may be formulated to prevent the fluid from clinging to or otherwise adhering to the inner surface of the material. In this instance, the first material layer may provide for easier movement of the fluid. It may be desired, however, to have some fluid stick to the material layer in order to develop a firmer support feeling for a user. Thus, the first material layer may augment any tackiness of the fluid thereby creating more shear loading in the fluid during movement. A second material layer may be applied to the outer surface of the first material layer. The second material layer may be formulated and constructed or aesthetic purposes and to create a desired tactile sensation. Additionally, the second layer may be coded, such as, for example, by color or texture, to indicate the location or composition of regions of the seat cushion assembly 20 or of various additional cushions, such as supplemental pads as will be explained below in detail.

As shown in FIG. 5, the upper layer 22 further includes cavities 60, 64, and 68 that correspond to chambers 40, 44, and 48, though such is not required. The cavities 60, 64, and 68 are sized to accommodate a fluid level sufficient to provide a reduced-pressure support of the user and allow the gathers 50 to be formed on the upper layer 22. The chambers 40, 44, and 48 are formed when the upper layer 22 and lower layer 24 are engaged together as will be described in detail below. Each of the chambers 40, 44, and 48 may contain the same isolation fluid or may contain different isolation materials so that the seat cushion assembly 20 may be softer in some areas and firmer in other areas.

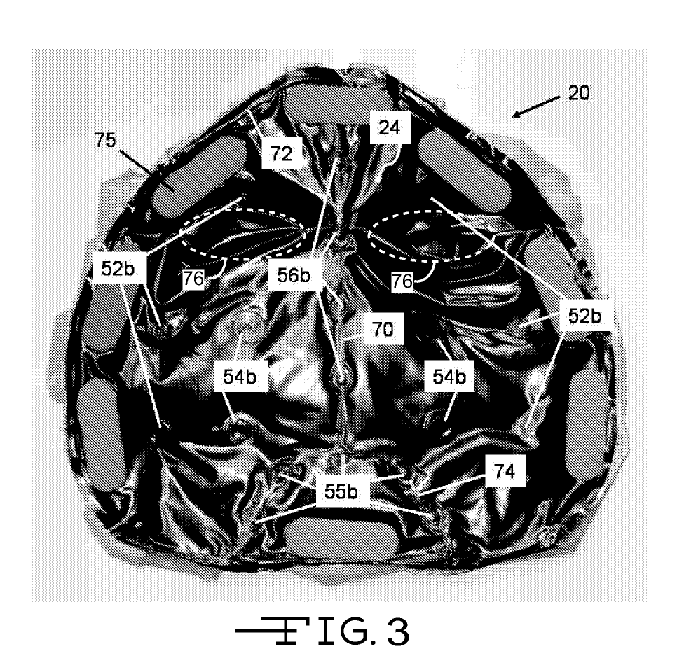

Referring now to FIGS. 3, 7A and 8, the upper layer 22 includes a plurality of first attachment points 52a that engage corresponding attachment points 52b on the lower layer 24. As shown in FIGS. 7A and 8, when the material of the upper and lower layers 22, 24 are spread out to their full width before attachment to each other, the relative spacing of the attachment points 52a on the upper layer 22 is larger than the relative spacing of the corresponding attachment points 52b on the lower layer 24. Similarly, upper layer second attachment points 54a and lower layer second attachment points 54b are engaged together. The second attachment points 54a and 54b may further include a fastening structure 37 attached to the upper layer 22, though the fastening structure is not required. The fastening structure 37 is shown as a portion of a hook and loop fastener, though any suitable fastener may be used. Additionally, any number of fastening structures 37 may be provided including more in number than corresponding supplemental pads 30. In one embodiment of the seat cushion system 22, no attachment points are provided. The larger relative spacing between attachment points 52a compared to attachment points 52b also facilitates forming the gathers 50.

As shown in FIGS. 3, 7A and 8, there are also a plurality of upper layer third attachment points 56a and corresponding attachment points 56b that are positioned along a center seam 70 between the chambers 44 and 48. A plurality of alignment points 58a and 58b are located about the perimeter of the upper and lower layers 22 and 24. The upper and lower layer alignment points 58a and 58b are coincidentally positioned and a perimeter seam 72 is formed adjacent thereto. In one embodiment, the alignment points 58a and 58b do not result in the formation of a discrete “spot weld” at the juncture of the upper and lower layers 22 and 24, as is the case with the attachment points described herein. A plurality of attachment points 55a and 55b are positioned to form a portion of the perimeter of the chamber 40. Additionally, a chamber seam 74, partially defining the chamber 40, is formed along the path defined by the attachment points 55a and 55b. The attachment and alignment points 52a,b; 54a,b; 55a,b; 56a,b; and 58a,b may be provided in fewer or greater numbers than shown.

As shown in FIG. 3, the center seam 70, the perimeter seam 72, and the chamber seam 74 are fluid tight seals that are formed through a heat bonding or “welding” process. Such processes are well known in the art. Other processes for forming the seams can be used, such as chemical welding, adhesive bonding, ultrasonic welding, crimping and the like. The seams 70, 72, and 74 cooperate to define the three chambers 40, 44, and 48 which are fluid tight chambers in order to retain the isolation fluid or medium described above. The lower layer 24 may further include a plurality of seat cushion fasteners 75. Though illustrated in FIG. 3 as being disposed about the perimeter of the lower layer 24, the fasteners 75 may be located anywhere and in any number desired. The lower layer 24 may optionally include two spaced-apart bottom pleats 76. The bottom pleats 76 are formed to permit the seat cushion 22 to better conform to the contours of the base 35.

Referring now to FIG. 7B, there is illustrated another embodiment of an upper layer, shown generally at 122, that is configured to be coupled to the lower layer 24 in a similar manner to the upper layer 22. The upper layer 122 includes first attachment points 152a. The first attachment points 152a are illustrated as singular attachment holes, however, any odd number of attachment holes may be used. The first attachment points 152a are arranged onto a mounting fixture that will be described below. As described above, the first attachment points 52b of the lower layer 24 are similarly bonded or otherwise attached to the first attachment points 152a. The upper layer 122 further includes second attachment points 154a positioned toward the inner portion.

The upper layer 122 further includes groupings of third attachment points 156a and alignment points 158a. The groupings of the third attachment points 156a are oriented along a center seam, similar to the center seam 70 described above. The groupings of alignment points 158a are positioned around the upper layer perimeter. The grouping of the third attachment points 156a and alignment points 158a are arranged onto a mounting fixture, that will be described below, in a successive order to position the material in an “S” shaped cross sectional configuration. The S-shaped groupings 156a and 158a form pleats that aid in managing the flow of material into gathers, similar to gathers 50. Additionally, the upper layer 122 includes groupings of attachment points 155a that form a portion of the perimeter of a chamber, similar to the chamber 40. The groupings of attachment points 155a are formed into an “S”-shaped configuration similar to the attachment points 156a and alignment points 158a described above. A single attachment point 155 is positioned at the intersection of the three regions, corresponding to portions of the chambers 40, 44, and 48 of FIG. 2.

As shown in FIG. 2, the gathers 50 are formed from the excess material of the upper layer 22 to provide a reduction in surface tension when the seat is loaded by a user. The reduction in surface tension reduces the hammock effect that normally would increase localized pressure on the user's pressure sensitive points. The gathers 50 may be formed having different amounts of excess material and hence different surface tension characteristics. The surface tension characteristic is related to the tensile load that stretches or otherwise causes the material of the seat cushion assembly 20 to become taut when subjected to an applied load, especially a concentrated applied load such as created by a user's ischial tuberosities. The surface tension characteristic may be inversely related to the amount of excess material that forms the gather 50. In other words, the more material that is used to form the gather 50, the greater the freedom of movement that is created for the material or gather 50 when reacting to the load applied by a boney prominence of a user onto the cushion surface. This greater freedom of movement of the gathers 50 lowers the surface tension characteristic for the specific region of the seat cushion assembly 20. Thus, the applied load of a boney prominence causes movement of the material without a corresponding substantial increase in the tensile load applied to the material or stretching of the material. The lack of increased surface tension reduces pressure on the boney prominences or protrusions.

In one example of operation of the seat cushion system 10, as a user's ischial tuberosity (IT) applies a concentrated load onto the seat cushion assembly 20, the gathers 50 of the upper layer 22 of the seat cushion assembly 20 tend to conform around the boney prominence and deflect or otherwise sink into the cushion. Because the gathers 50 have an excess of material, the material pays out against the user's IT and surrounding area without stretching. This sinking movement also causes the fluid to move away from the peak deflection at the center of the IT. The fluid moves away from the IT center and collects at the point where the material of the gather 50 folds back toward the cushion. Put another way, the fluid moves away from the pointed portion of the IT to cradle and support the surrounding area. The collection of fluid becomes compressed by the tissue surrounding the IT and creates a hydrostatic loading effect on the general area of the ITs. This hydrostatic loading applies substantially the same pressure over the IT and the surrounding tissue area. Thus, the pressure applied to the IT and surrounding areas has a generally equal distribution of load over a larger area of a user's buttocks.

The gathers 50 may be arranged on the upper surface so that the higher surface tension gathers 50 (those formed from less excess material) are positioned closer to the perimeter of the seat cushion assembly and also closer to the perimeter seam 72. This arrangement of the gathers 50 produces a surface tension gradient across a portion of the upper layer 22. The surface tension gradient may transition from a higher surface tension region to a lower surface tension region. The higher surface tension region may include gathers 50 having a relatively high surface tension characteristic which may be positioned near the perimeter of the seat cushion assembly 20. The lower surface tension region may include gathers 50 having a relatively low surface tension characteristic which may be located toward the center of the seat cushion assembly 20. In particular, the gathers 50 having the lower surface tension characteristic may be positioned near the attachment points 54a and positioned under the user's ischial tuberosities. The arrangement of the gathers 50, however, may be in any suitable configuration to provide isolation between a seat base, such as a wheelchair seat sling, and the user.

The gathers 50 having the higher surface tension characteristic will generally include less excess material than the gathers 50 having the lower surface tension characteristic. Though not required, generally the gathers 50 having the lower surface tension characteristic can accommodate a larger volume of isolation fluid. However, the gathers 50 having the lower surface tension characteristic may not always contain a larger volume of fluid therein. The gathers 50 are also in fluid communication with each other, at least within the particular chamber 40, 44, and 48, though such is not required.

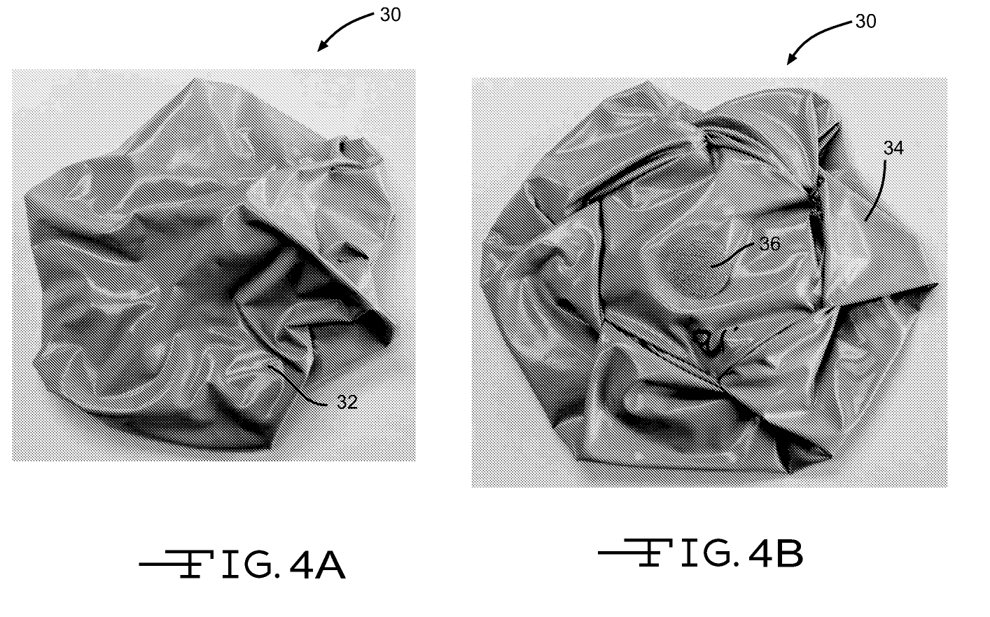

Referring now to FIGS. 4A, 4B, and 4C, there is illustrated an upper surface 32 and a lower surface 34, respectively, of the supplemental pad 30. The supplemental pads 30 may be structured similarly to the chambers 40, 44, and 48 if desired. The lower surface 34 may include a fastening structure 36 attached thereto, though such is not required. The fastening structure 36 is shown as a hook and loop fastener though any suitable device may be used. The fastening structure 36 of the supplemental pad 30 engages the cooperating fastening structure 37 of the upper layer 22 to attach the supplemental pad 30 to the seat cushion assembly 20. As shown in FIG. 4C, the fastening structure may be an elongated fastening structure 136 to provide a range of adjustment within each of the plurality of locations where the supplemental pad 30 may engage the upper layer 22. In one embodiment, fastening structure 36 of the supplemental pad 30 may be a permanent attachment point, such as the “spot welds” used to construct the seat cushion assembly 20. In another embodiment, the fastening structure 36, along with the fastening structure 37 on the seat cushion assembly 20, may be cooperating snaps, attracting magnets, pressure sensitive tape, and the like. Alternatively, the fastening structure 36 may secure the supplemental pad 30 in one direction, such as perpendicular to the upper layer 22, and facilitate movement or adjustment of the pad 30 in a second direction, such as relative sliding movement along the upper layer 22.

Referring to FIG. 1, upper surface 32 of the supplemental pad 30 is shown having an area that is smaller than the area of the upper layer 22 of the seat cushion assembly 20. The assembled area of the supplemental pads 30 may be generally between one half and 1/20th of the surface area of the seat cushion assembly 20. More particularly, the supplemental pads 30 may be generally between 1/10th and 1/12th of the area of the upper layer 22 of the seat cushion assembly 20, though such is not required. Alternatively, the supplemental pads 30 may have any surface area relative to the seat cushion assembly 20 including the same or a larger area. The supplemental pads 30 may also have a fluid volume capacity that is smaller, larger, or the same as the seat cushion assembly 20 or any of the chambers 40, 44, and 48.

The supplemental pads 30 may include a cavity 38 containing a fluid, a foam, or a combination of fluid and foam, as described above. The supplemental pad 30 may be provided with a different viscosity, stiffness, damping, or other isolation characteristic than the seat cushion assembly 20. The isolation characteristic of the supplemental pad 30 may be changed, for example, by introducing a different material into the cavity 38 than is contained within the chambers 40, 44, and 48. The stiffness characteristic of the supplemental pads 30 may further be adjustable by means of fluids that are responsive to energy fields, such as magneto-rheological fluids, electro-rheological fluids, and the like. The supplemental pads 30, and alternatively any of the chambers 40, 44, and 48, may include an energy supply structure, such as an electromagnet (not shown) that magnetically communicates with the fluid. The fluid may change apparent stiffness characteristics when the magnetic field is introduced, such that the supplemental pad 30 becomes stiffer or more viscous. Alternatively, the fluid may become less viscous if so desired.

The fluid may be introduced into the cavity 38 by way of a filling port 39. The filling port 39 is illustrated as a hollow tubular segment of the supplemental pad 30. The filling port 39 may further be folded over and sealed onto the lower surface 34. In one embodiment, the supplemental pads 30 are further constructed so that at least one gather, similar to gather 50 is provided thereon. The folded filling port 39 may provide additional gathers.

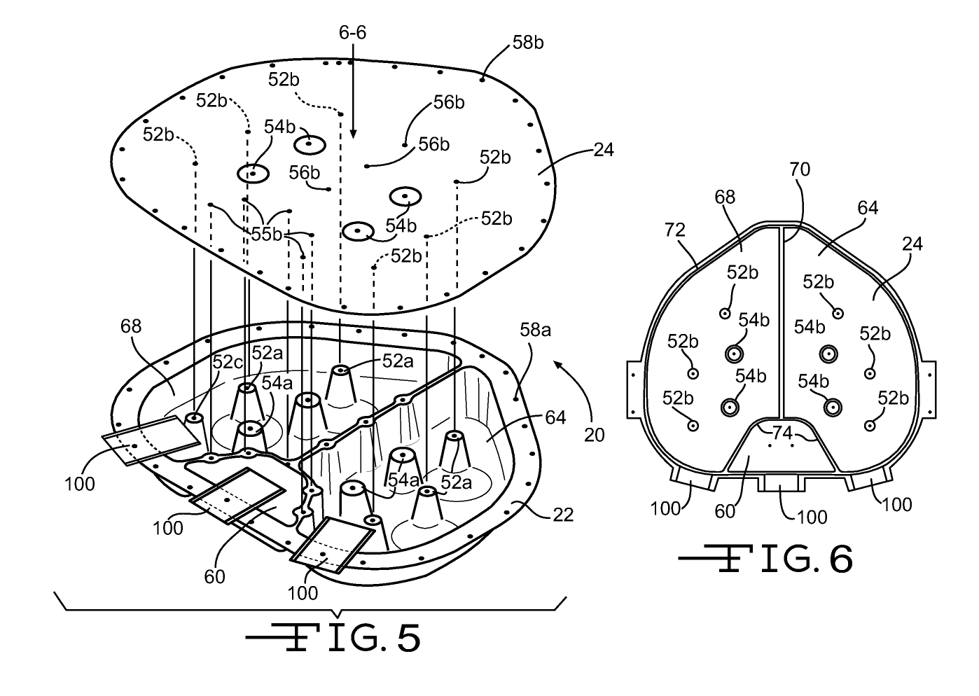

As shown in FIGS. 5 and 6, a spout 100 is in fluid communication with each of the cavities 60, 64, and 68 prior to completed formation of the perimeter seam 72. The spouts 100 permit fluid to be introduced to each cavity 60, 64, and 68 during assembly of the seat cushion portion 20. It is to be understood that the spout 100 is optional, and other means can be used to fill the cavities. Additionally, the supplemental pads 30 may include a spout, similar to spout 100, in lieu of the filling port 39.

The chambers 44 and 48 and the supplemental pads 30 are preferably positioned in general alignment with pressure sensitive areas of the user. In particular, the user's ischial tuberosities, i.e. the bony protrusions in the buttocks area, are preferably supported in a reduced pressure manner by the chambers 44 and 48 and further by at least one of the supplemental pads 30. The supplemental pads 30 may have a stiffness characteristic that is more compliant than is provided by the chambers 40, 44, and 48 to provide a softer interface to the user.

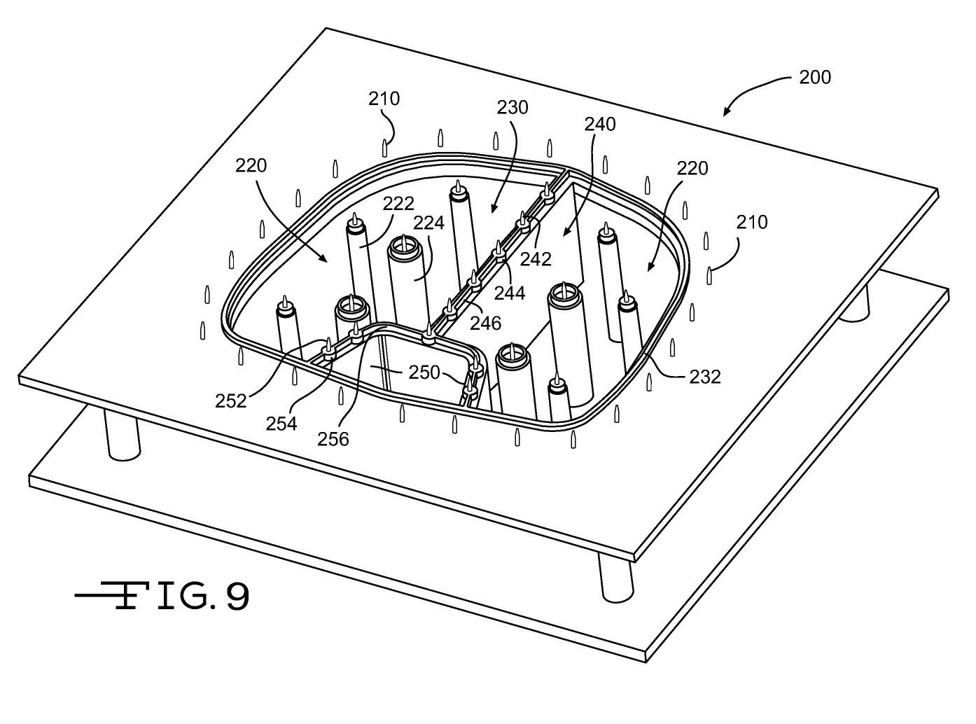

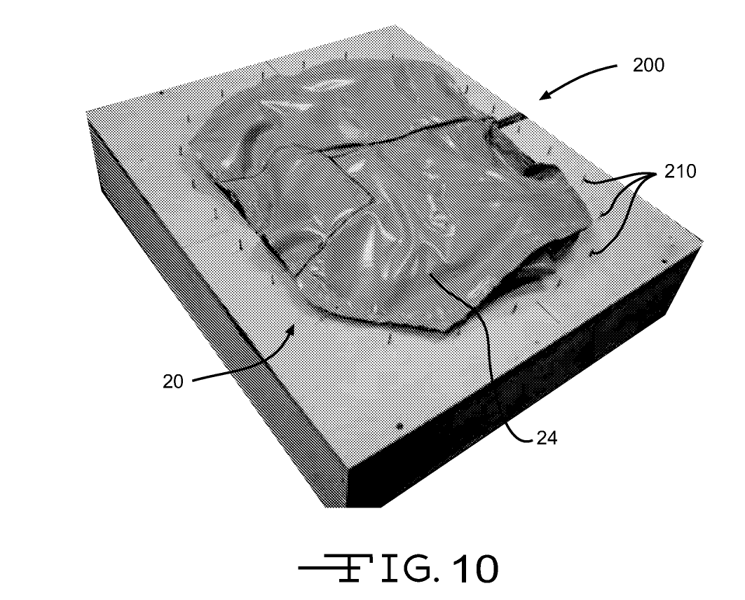

Referring now to FIGS. 9 and 10, there is illustrated an apparatus 200 for forming the seat cushion assembly 20. The apparatus is an assembly jig 200 having a plurality of perimeter locating points 210 and a plurality of interior locating points 220 arranged in an interior cavity portion 230 of the jig 200. The perimeter locating points 210 engage the plurality of alignment points 58a and 58b that are located about the perimeter of the upper and lower layers 22 and 24. The perimeter locating points 210 of the alignment jig are illustrated as a plurality of pins that extend from the surface of the jig 200. The pins 210 may be any structure that is capable of locating and temporarily holding the upper layer 22 and the lower layer 24 for subsequent forming and bonding operations. The interior locating points 220 are illustrated as first assembly posts 222 and second assembly posts 224. The assembly posts 222 and 224 also terminate in pins, similar in function to the perimeter pins 210.

The assembly posts 222 and 224 engage the attachment points 52a, 54a and 56a of the upper layer 22 and attachment points 52b, 54b, and 56b of the lower layer 24 and may further generate the spot weld attachment between the upper and lower layers 22 and 24. The first assembly posts 222 are illustrated having a smaller diameter than the second assembly posts 224. The larger diameter of the second assembly posts 224 is configured to further secure the fasteners 37 onto the upper layer 22. The plurality of posts 220 extending up from a interior cavity area 230 of the alignment jig may be arranged in any suitable formation to produce the desired gather configuration.

The locating points 210 and 220 align and position the attachment points 52a, 54a and 56a of the upper layer 22 with the attachment points 52b, 54b, and 56b of the lower layer 24 in a suitable spaced-apart relationship to provide a distribution of the gathers 50 suitable to form the desired surface tension gradient across the seat cushion assembly 20. A perimeter seam iron 232 is shown as a raised portion of the jig 200 and, in one embodiment, applies heat to the upper an lower layers to melt or otherwise bond the surfaces together. The attachment of the upper and lower layers 22 and 24 may be formed in any suitable manner that provides for fluid tight cavities, as indicated above.

A center ridge 240 divides the cavity 230 in two general halves for forming the chambers 44 and 48. The center ridge 240 includes a plurality of alignment pins 242 that extend from local spot weld pads 244. The local spot weld pads 244 are connected together by a center seam iron 246. The spot weld pad 244 and the center seam iron 246 form a continuous fluid tight connection between the upper and lower layers 22 and 24, along the center seam 70. The center ridge 240 terminates in a forward chamber ridge 250 that is similarly constructed. The forward chamber ridge 250 includes a plurality of alignment pins 252 that extend from local spot weld pads 254. The local spot weld pads 254 are connected together by a forward chamber seam iron 256 that connects to the center seam iron 246 to form the three separately fluid-tight chambers 40, 44, and 48.

The assembly jig 200 or the cavity 230 may further be connected to a vacuum source, if so desired, to facilitate the formation of the gathers 50. Alternatively, a positive pressure may be applied to the cavity side of the upper layer 22 to push the material of the upper layer 22 into the cavity 230 of the assembly jig 200. In yet another mode of operation, the gathers 50 may be collected by hand and moved away from the posts or the pins in any suitable relative direction.

The upper layer 22 is positioned onto the alignment jig 200 so that the various alignment and attachment points are located on the perimeter and interior pins. In one embodiment, the excess material of the upper surface 22 is positioned into the cavity 230. The lower layer 24 is likewise positioned onto the pins of the alignment jig 200 over the upper layer 22. In one embodiment, the lower layer 24 has the same attachment and alignment point dimensions as the relative dimensions of the pins, though such is not required. Once the upper and lower layers 22 and 24 are oriented and positioned on the jig 200, the various fluid tight seals may be formed thereon. A fluid tight seam or a plurality of fluid tight seams may be formed, by processes known in the art, to seal off the chambers 40, 44, and 48, as described above. The interior attachment points may be spot welded together to form the gathers 50 and also to maintain their general local positions relative to the remainder of the seat cushion assembly 20. Though the seat cushion assembly 20 is shown and described being assembled on the assembly jig 200 other methods and devices may be used to assemble the upper and lower layers 22 and 24.

The general local positioning of the gathers 50 is intended to allow the gathers 50 having a lower surface tension characteristic to move within portions of the interior area of the seat cushion assembly 20. The movement of the gathers 50 having a lower surface tension characteristic places these gathers within the vicinity of attachment points 54a where the user's ischial tuberosities are generally located. The gathers 50 having the higher surface tension characteristic may be positioned around the perimeter seam 72 and may be more restricted in the degree of movement as compared to the remaining gathers 50.

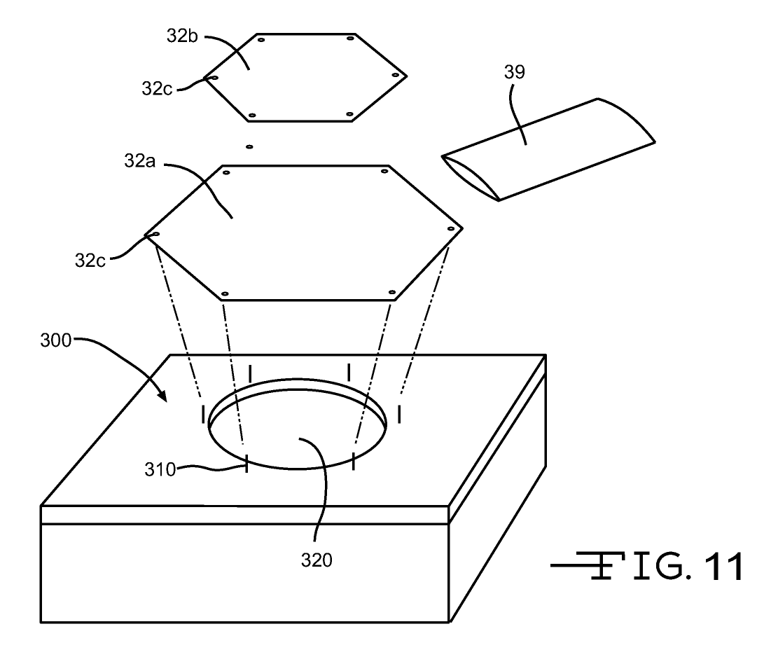

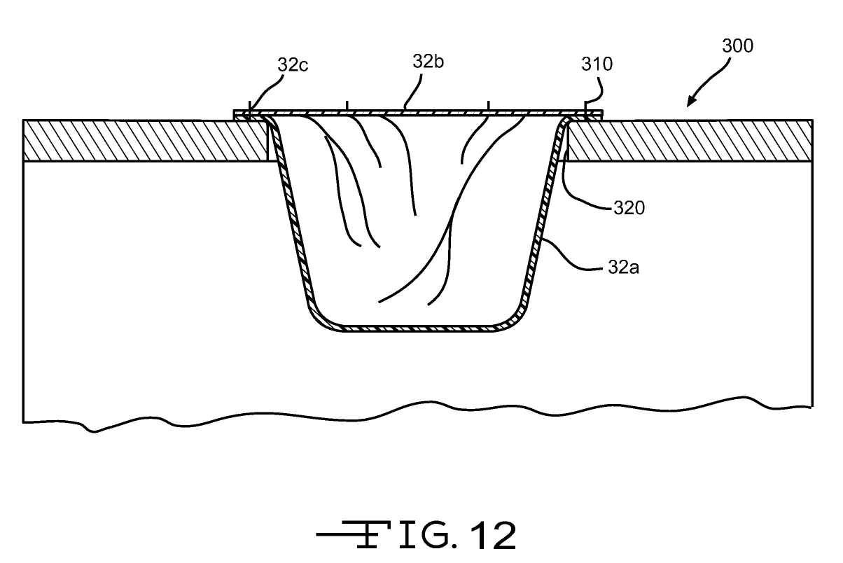

The supplemental pads 30 may be formed by an assembly jig 300, shown in FIGS. 11 and 12. The assembly jig 300 includes perimeter pins 310, shown oriented around a forming aperture 320. The perimeter pins 310 are similar to the pins 210 of the assembly jig 200. The assembly jig 300 further may include a perimeter seam iron (not shown) that is configured to form a perimeter seam weld between upper and lower pad layers 32a and 32b of the supplemental pad 32. The upper and lower layers 32a and 32b, which may be similar to the upper and lower layers 22 and 24 of the seat cushion assembly 20.

The pad upper and lower layers 32a and 32b also include alignment holes 32c that locate on the pins 310 of the assembly jig 300. The upper and lower pad layers 310 are brought together and a seam is formed about the perimeter. The supplemental pad 30 is also shown including the spout 39 for filling the supplemental pad 30 with isolation fluid. The perimeter seam may stop at the filling port 30 thus leaving an opening to introduce fluid therein.

The supplemental pad 30 may be twisted to form pleats and gathers to contain fluid if so desired. The supplemental pad 30 is then inverted to position the seams in the interior cavity 38. Thereafter, the fastening structure 36 may be attached to the lower surface 34 of the pad 30.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A seat cushion system comprising:
a seat cushion assembly having an upper layer and a lower layer defining a chamber, the chamber containing a first isolation fluid, the upper layer having a larger surface area than the lower layer; and
a supplemental pad attached to the seat cushion assembly and further containing a second isolation fluid.

2. The seat cushion system of claim 1 wherein the first isolation fluid is different from the second isolation fluid.

3. The seat cushion system of claim 2 wherein the first isolation fluid has a viscosity that is different from the viscosity of the second isolation fluid.

4. The seat cushion system of claim 1 wherein the supplemental pad is attached to the seat cushion assembly by a fastening structure enabling the supplemental pad to be readily removed from the seat cushion assembly.

5. The seat cushion system of claim 4 wherein the fastening structure is a hook and loop fastening structure.

6. The seat cushion system of claim 4 wherein the fastening structure enables the supplemental pad to be positioned in one of a plurality of positions of relative to the seat cushion assembly.

7. The seat cushion system of claim 4 wherein the supplemental pad is permanently attached to the seat cushion assembly.

8. The seat cushion system of claim 1 wherein a portion of a fastening structure is attached to the lower layer.

9. The seat cushion system of claim 4 wherein the fastening structure is a snap fit structure.

10. The seat cushion system of claim 4 wherein the fastening structure includes a sliding attachment arrangement.

11. The seat cushion system of claim 1 wherein the supplemental pad has an area in the range of 1/12th to ⅓rd of the area of the seat cushion assembly.

12. The seat cushion system of claim 1 wherein the supplemental pad is a plurality of supplemental pads, at least one of the supplemental pads being a different size than any remaining supplemental pad.

13. The seat cushion system of claim 1 wherein the seat cushion assembly has at least one gather.

14. The seat cushion system of claim 1 wherein the supplemental pad has at least one gather.

15. The seat cushion system of claim 1 wherein the seat cushion assembly includes a left chamber and a right chamber, the seat cushion assembly further including at least one of the supplemental pads attached to each of the left and right chambers.

16. A seat cushion system comprising:
a seat cushion assembly having an upper layer defining a first surface area and a lower layer defining a second surface area, the first surface area being larger than the second surface area resulting in excess material on the upper layer, the upper layer and lower layer being secured together by perimeter welds and a plurality of spot welds to form the excess material of the upper layer into a plurality of gathers, the gathers having a seat tension characteristic that permits movement of the excess material of the gathers in response to an applied load and a resulting deflection without a substantial stretching of the excess material forming the gathers.

17. The seat cushion system of claim 16 wherein the gathers having a higher seat tension characteristic are positioned about a perimeter of the seat cushion assembly and the gathers having a lower seat tension characteristic are positioned within an inner portion of the seat cushion assembly.

18. The seat cushion system of claim new 16 wherein the upper layer and the lower layer cooperate to define a chamber and further define a tension gradient across the upper layer, the tension gradient being higher towards the perimeter and lower towards the center of the seat cushion assembly.

19. The seat cushion system of claim 16 wherein the gathers are arranged to produce a tension gradient across a portion of the upper layer that increases toward the perimeter, the upper layer having the spot welds that further maintain the general localized orientation of the plurality of gathers, and the plurality of gathers contain an isolation fluid.

20. A method of forming a seat cushion system comprising:
(a) providing an assembly jig having spaced-apart perimeter locating points that define a perimeter and spaced-apart interior locating points that define an interior area;
(b) providing an upper layer and a lower layer, the upper layer having a greater surface area than the lower layer such that the upper layer includes excess material;
(c) positioning the upper layer on the spaced-apart perimeter locating points and the spaced-apart interior locating points such that the upper layer excess material is disposed between adjacent locating points;
(d) positioning the lower layer onto the locating points and over the upper layer;
(e) forming a spot weld at each of the interior locating points;
(f) forming a seam adjacent to the perimeter locating points to form at least one chamber; and
(g) introducing an isolation fluid into the at least one chamber.

21. The method of claim 20 wherein the assembly jig of step (a) includes a cavity.

22. The method of claim 21 wherein step (c) includes using a vacuum to draw down upper layer excess material.

23. A seat cushion system comprising:
a seat cushion assembly having an upper layer defining a first surface area and a lower layer defining a second surface area, the first surface area being larger than the second surface area resulting in excess material on the upper layer, the upper layer and lower layer being secured together by perimeter welds and a plurality of spot welds to form the excess material of the upper layer into a plurality of gathers, the spot welds further maintaining the general localized orientation of the plurality of gathers, and at least one of the plurality of gathers containing an isolation fluid.
